(19) United States
(12) Patent Application Publication
(10) Pub. No.: US 2011/0305526 A1
(43) Pub. Date: Dec. 15, 2011

(54) End Piece For Arcuate Void Forms

(76) Inventors: Michael L. Turner, Englewood, CO (US); John W. Gates, Fort Worth, TX (US)

(21) Appl. No.: 12/814,287

(22) Filed: Jun. 11, 2010

(51) Int. Cl. B28B 7/16; E02D 5/34

(52) U.S. Cl. 405/255; 405/257

(57) ABSTRACT

A universal end wall component for closing the open side of an arcuate end or circular void form, used for creating space between expansive soils and a concrete structure, comprising, an elongated panel having crenellated upper and lower edges forming a plurality of spaced apart tabs that are bendable to form fastening surfaces for attaching the end wall component to the upper and lower panels of the void form.

### FIELD OF THE INVENTION

The present invention relates generally to void forms that create a space between expansive soils and concrete structures that are poured in positions over such soils. The present invention constitutes an improvement on the arcuate end corrugated form void that is the subject matter of U.S. Pat. No. 5,915,884.

### BACKGROUND OF THE INVENTION

In concrete construction where walls and slabs must be separated from expansive soils it is necessary to support these structures with laterally spaced apart concrete piers that are poured in place into holes in the ground. If the void forms for walls and slabs are put in place before the piers are poured it is necessary that the void forms that surround the pier position be shaped to act as a form for the portion of the pier that may extend above the level of the ground on which the void forms are placed. Where void forms that are intended to create a void under a poured concrete wall, grade beam or floor slab are placed after a pier has been poured it is necessary that the void forms be shaped so that they correctly void the circular edge of a drilled pier, that is, they abut and are flush with the surface of the pier in order to prevent the concrete that is poured for the wall or slab from leaking into the space between the pier and the void form.

In both cases it is essential that the void form have the same contour as the pier to which it abuts. In the case of beam void that creates a space between the ground and a wall the abutting void form must be arcuate in shape. In the case of creating a void beneath a floor slab, the pier abutting void form must be circular to surround the pier.

In practice, it is not always known, when acquiring the form void for a construction project, what the size of the piers will be. Accordingly, the large area void forms for creating space beneath a floor slab and the elongated void forms for placement under a wall to be poured must be field cut to accommodate the particular piers encountered at the job site. Cutting an arcuate pattern in the pre-manufactured void forms requires that a normal side wall of the void be cut away creating an opening into the interior of the form. Such an opening is unacceptable for several reasons. The open unsupported cut end of the form will not adequately support the weight of the concrete that is poured on top of the form. Further, concrete may run into the interior of the form which negates the purpose of the void form by eliminating the space between the wall or slab and the ground. It is therefore necessary to create an arcuate or circular end piece that will cover the opening in the form created by cutting the form to match the contour of the pier. Creating and properly attaching such an end piece in the field is usually done with scrap material and is unsatisfactory at best.

It is therefore the principal object of the invention to provide a vertically supported radial sealed edge structure for a void form.

Another object of the invention is to provide a universal end piece that can be custom fit in the field to any perimetric length of open ended void form and can be affixed to the void form easily and in a manner that will create the necessary loading strength for the arcuate edge of the void form.

### SUMMARY OF THE INVENTION

The present invention is a universal end wall component for closing the open side of an arcuate or circular void form structure comprising an elongated panel of bendable material where the lengthwise top and bottom mutually parallel edges of the panel are crenellated, forming a plurality of integral tastening tabs projecting from the top and bottom edges of the panel. The panel also has a plurality of spaced apart scores in one of the facing surfaces of the panel that are perpendicular to the top and bottom edges. The scores in the surface of the panel facilitate forming the panel into a geometric arc (substantially arcuate) or a convex polygonal shape. The panel is cut to a length appropriate to the perimetric length of the open end of the void form, whether an arc or an entire circle. At the time the end wall panel is inserted between the flat upper and lower plates of the void form the fastening tabs are bent ninety degrees to be parallel with the upper and lower panel members of the void form and flush with the inside surfaces of those panels. The tabs are then affixed to the respective panels with staples, glue or other means.

### DESCRIPTION OF THE DRAWINGS

FIG. 1 is a top view of the crenellated end piece panel.

FIG. 2 is a perspective view of a typical beam void form with an arcuately cut end. The interior bracing is not shown.

FIG. 3 is an enlarged fragmentary perspective view of a typical beam void form with the end piece of the present invention affixed to the arcuate end of the void form forming an end piece closure for the void form.

### DETAILED DESCRIPTION OF PREFERRED EMBODIMENT

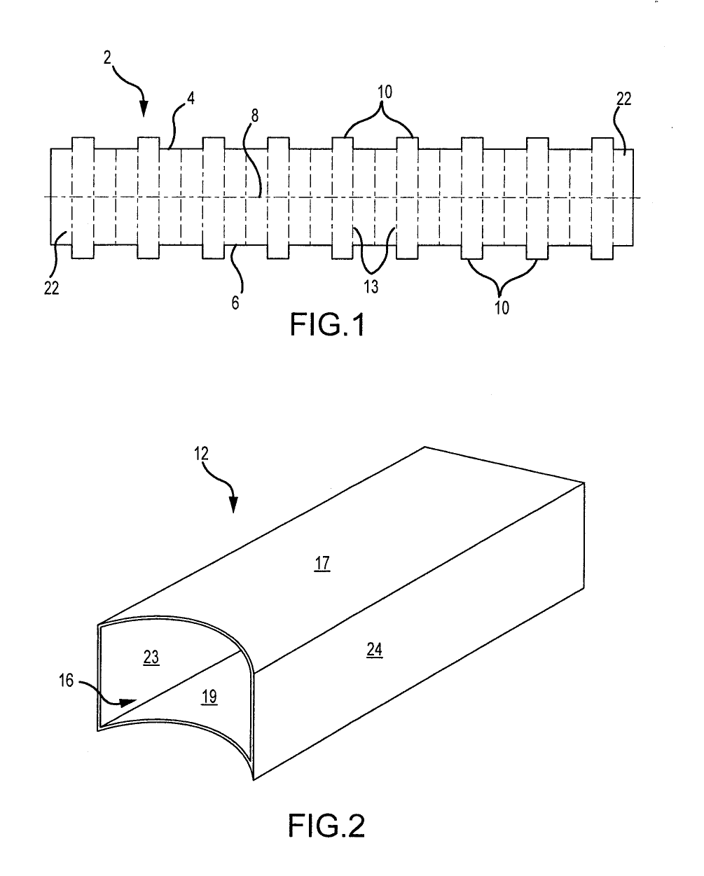

Referring to the drawings, FIG. 1 illustrates the end piece panel 2 of the present invention. The top and bottom edges 4 and 6 are mutually parallel and are parallel to the longitudinal axis 8 of the panel. Crenellations in the top and bottom edges of the panel form a plurality of projecting tabs 10. Preferably the panel is constructed from the same material as the void form into which it will be inserted, namely corrugated paper or plastic.

In an alternative embodiment the fastening tabs are constructed from a plurality of elongated strips of corrugated paper or plastic material which are attached to the rectangularly shaped end piece panel in spaced apart and mutually parallel configuration. The terminal ends of each strip constitute a pair of tabs that respectively extend beyond the top and bottom edges of the end piece panel.

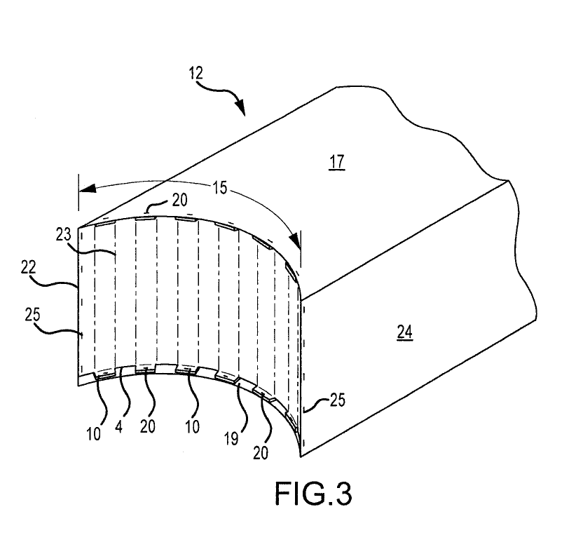

An exemplary beam void form 12 for creating space between a concrete beam or wall is shown in FIGS. 2 and 3. The illustrated section of beam void is a section intended to be positioned flush with the arcuate side of a drilled pier. The interior of the void form comprises supporting members, such as a honeycomb structure, as shown in U.S. Pat. No. 5,915,884, but the supporting structure forms no part of the present invention and is not shown for clarity purposes.

In operation, the panel 2 is cut to a length that will span the perimetric dimension 15 of the opening 16 between the upper panel member 17 and the lower base panel member 19 of the void form 12. The end piece panel 2 is formed into a convex polygon or a substantially arcuate sector of such a polygon by bending the end panel at each of a plurality of score lines 13. The substantially arcuately formed geometric panel is inserted into the opening 16 of the void form 12 and the tabs 10 are bent ninety degrees to be flush with the inside surfaces of the top and bottom void form panel members 17 and 19. Preferably, the tabs are attached to the upper and lower panels with staples 20, but gluing or other forms of securement may be used. The longitudinal ends 22 of the end panel 2 are bent along a score line 13 to be flush with the inside surface of the respective side walls 23 and 24 of the void form and are secured thereto with staples 25 or other means of securement.

In addition to sealing the arcuate end of the void form against the intrusion of concrete into the interior of the form, the tabbed end piece provides structural support for the arcuate end edge portion of the form that resists the load of poured concrete that comes in contact with the form.

What is claimed is:

1. A universal end wall component for closing the open side of a void form structure comprising,
an elongated panel having a longitudinal axis and opposed facing surfaces, and
crenellated upper and lower edges that are parallel to the longitudinal axis.

2. The end wall component of claim 1 and including a plurality of spaced apart scores in one of the facing surfaces that are perpendicular to the longitudinal axis.

3. The end wall component of claim 2 where the panel is constructed of corrugated paper.

4. An arcuate form void for creating a space beneath a concrete structure adjacent a curved pier, comprising,
a rectangular shell having,
a planar top member having an arcuately shaped first edge and a plurality of second edges,
a planar base member having an arcuately shaped first edge and a plurality of second edges,
a plurality of side members interconnecting the mutually parallel top and base members along their second edges,
a substantially arcuately shaped end panel having a body portion with inside facing and outside facing surfaces and top and bottom edges, said end panel disposed between the top and base members in a position interconnecting the arcuate edges of the top and base members and spaced inwardly therefrom, said end panel having,
a plurality of spaced apart opposing tab pairs extending from the top and bottom edges of the end panel in a direction parallel to the top and base panels,
means affixing said tabs to the top and bottom panels for securing the end panel to the top and bottom members.

5. The form void of claim 4 where the end panel is scored along spaced apart lines that are perpendicular to the top and bottom edges of the panel.

6. The form void of claim 4 where the tabs are integral with the body portion of the end panel.

7. The form void of claim 4 where each pair of opposing tabs comprise an elongated strip having a longitudinal axis and terminal ends and where each strip is attached to one of the surfaces of the arcuately shaped panel in a position where the longitudinal axis of the strip is perpendicular to the top and bottom edges of the panel and the terminal ends of the strip extend outwardly from the top and bottom edges of the panel.
